(19) United States
(12) Patent Application Publication
(10) Pub. No.: US 2022/0361447 A1
(43) Pub. Date: Nov. 17, 2022

(54) PET BRUSH WITH DESHEDDING SYSTEM

(71) Applicant: INSYNC PRODUCTS GROUP LTD., Sheung Wan (HK)

(72) Inventor: Rishi Mahtani, Kowloon (HK)

(21) Appl. No.: 17/738,748

(22) Filed: May 6, 2022

Related U.S. Application Data
(60) Provisional application No. 63/188,709, filed on May 14, 2021.

(51) Int. Cl. A01K 13/00; A46B 5/02; A46B 15/00; A46B 9/02

(52) U.S. Cl. CPC A01K 13/002; A46B 5/021; A46B 15/0081; A46B 9/023; A46B 2200/1093

(57) ABSTRACT

A pet brush includes a body having a retractable deshedding blade, a deshedding brush, and a cleaning surface. The pet brush further includes a handle and a cover. In certain embodiments, a pet brush includes a body having a first retractable deshedding blade, a second retractable deshedding blade, a deshedding brush, and a cleaning surface. The pet brush further includes a handle and a cover.

### CROSS-REFERENCE TO RELATED APPLICATIONS

This application claims the benefit of U.S. Provisional Application No. 63/188,709 filed on May 14, 2021. The entire disclosure of the above application is incorporated herein by reference.

### FIELD

The present disclosure relates generally to a pet brush, and more particularly, to a pet brush having a deshedding system.

### INTRODUCTION

This section provides background information related to the present disclosure which is not necessarily prior art.

Millions of people worldwide own and care for one or more pets in their home. While the relationship between a person and their pet may be extremely rewarding, there may be certain drawbacks to owning a pet. For example, pets require regular grooming and maintenance with respect to various body parts such as teeth, nails, and hair. This aspect of pet ownership may be expensive. Additionally, excessive hair may be problematic for people with allergies, and may leave a pet owner's home and personal belongings looking dirty and unkempt.

Various products for grooming and removing pet hair are known. For example, certain pet brushes target the undercoat of a pet. However, these brushes often leave undesirable loose hair behind on the pet's topcoat and only extract hair in one direction. Additionally, these brushes may be cumbersome to clean and remove hair from. Other known pet brushes include more traditional brushes targeting the topcoat of the pet. For example, it is known to wear a glove that includes a brush disposed thereon for grooming. However, these pet brushes leave behind the undercoat leading to excessive shedding for many pets. It is also known to use various materials to clean loose fur from pets and other surfaces such as furniture and clothing. However, these materials also do not eliminate the underlying shedding problem.

Accordingly, there is a continuing need for a pet brush that targets the undercoat of a pet, the topcoat, and any loose hair on or around the pet. Desirably, this brush would be efficient, safe, easy-to-use, and easy to clean.

### SUMMARY

In concordance with the instant disclosure, a pet brush that targets the undercoat of a pet, the topcoat, and any loose hair on or around the pet, and that is efficient, safe, easy-to-use, and easy to clean, has surprisingly been discovered.

In certain embodiments, a pet brush comprises a body including a handle for gripping the pet brush, a first retractable deshedding blade, a deshedding brush disposed on a first surface of the pet brush, and a cleaning surface disposed on a second surface of the pet brush. The second surface may on be an opposite side of the body from the first surface. The first retractable deshedding blade is moveable between a retracted position within the body and an extended position outside the body. For example, a retracting mechanism may be used move the first retractable deshedding blade from the retracted position within the body to the extended position outside the body. In certain embodiments, the retracting mechanism slidably directs the first retractable deshedding blade between the retracted position within the body and the extended position outside the body. In certain embodiments, a stopper element is configured to remove pet hair from the first retractable deshedding blade when the first retractable deshedding blade is moved from the extended position outside the body to the retracted position within the body. The first retractable deshedding blade may include a plurality of protrusions that extend outwardly from a first end of the first retractable deshedding blade when the first retractable deshedding blade is moved to the extended position. The first retractable deshedding blade may include one of a flat edge, a sloping edge, and combinations thereof.

In certain embodiments, the pet brush further includes a second retractable deshedding blade that is moveable between a retracted position within the body and an extended position outside the body. A stopper element may be placed within a middle of the first retractable deshedding blade and the second retractable deshedding blade to remove pet hair when the first retractable deshedding blade and the second retractable deshedding blade are moved from the extended position outside of the body to the retracted position within the body. The first retractable deshedding blade may include a first retractable deshedding blade flat edge and a first retractable deshedding blade sloping edge and the second retractable deshedding blade may include a second retractable deshedding blade flat edge and a second retractable deshedding blade sloping edge. The first retractable deshedding blade sloping edge may face the second retractable deshedding blade sloping edge.

The deshedding brush of the pet brush may include a plurality of protrusions. The cleaning surface may include a member selected from a group consisting of a lint cleaning brush, a microfiber material, a soft bristle brush, a sticky surface, and combinations thereof. A cover may be configured for receiving the pet brush. The cover may include an inner surface adapted to remove pet hair from the cleaning surface of the pet brush when the pet brush is removed from the cover. The cleaning surface may angle in a first direction, while the inner surface of the cover angles in a second opposite direction, for removing pet hair and dander from the pet brush.

In certain embodiments, a method of using a pet brush includes the steps of extending a deshedding blade from a body of the pet brush. The pet brush may be applied to a pet using one of the deshedding blade, a deshedding brush, and a cleaning surface, or a combination thereof. Then, the deshedding blade may be retracted into the body of the pet brush. During retraction of the deshedding blade, pet hair may be removed or ejected from the deshedding blade. The pet brush may also be engaged with a cover to remove pet hair from the deshedding brush and the cleaning surface. A lid of the cover may be removed to dispose of the pet hair collected within the cover.

Further areas of applicability will become apparent from the description provided herein. It should be understood that the description and specific examples are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front perspective view of a first embodiment of a pet brush, in accordance with the present technology;

FIG. 2 is a rear perspective view of the first embodiment of the pet brush, in accordance with the present technology;

FIG. 3A is a bottom perspective view of the first embodiment of the pet brush with a first retractable deshedding blade and a second retractable deshedding blade shown in a retracted position, in accordance with the present technology;

FIG. 3B is a cut-away view of the retracting mechanism of the first embodiment of the pet brush moved into a position operable to place the first retractable deshedding blade and the second retractable deshedding blade in the retracted position, in accordance with the present technology;

FIG. 4A is a bottom perspective view of the first embodiment of the pet brush with the first retractable deshedding blade and the second retractable deshedding blade shown in an extended position, in accordance with the present technology;

FIG. 4B is a cut-away view of the retracting mechanism of the first embodiment of the pet brush moved into a position operable to place the first retractable deshedding blade and the second retractable deshedding blade in the extended position, in accordance with the present technology;

FIG. 5 is a rear perspective view of the first embodiment of the pet brush, shown with a cover on, in accordance with the present technology;

FIG. 6 is a rear perspective view of the first embodiment of the pet brush, shown with the cover partially removed, in accordance with the present technology;

FIG. 7 is a front perspective view of the cover of the first embodiment of the pet brush, the cover shown with a lid removed, in accordance with the present technology;

FIG. 8 is a side elevational view of the first embodiment of the pet brush moving through hair of a pet, in accordance with the present technology;

FIG. 9A is a cutaway perspective view of a second embodiment of a pet brush, in accordance with the present technology;

FIGS. 9B-9F depict a top plan view, a side elevational view, a top perspective view, and end views, respectively, of a retractable deshedding blade of the second embodiment of the pet brush, in accordance with the present technology;

FIG. 10A is a cutaway perspective view of the first embodiment of the pet brush, in accordance with the present technology;

FIGS. 10B-10E depict a top plan view, a side elevational view, a top perspective view, and an end view, respectively, of a retractable deshedding blade of the first embodiment of the pet brush, in accordance with the present technology;

FIG. 11 is a flowchart of a method of using a pet brush, in accordance with the present technology.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9,1-8,1-3,1-2,2-10,2-8,2-3,3-10,3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the FIGS. is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology relates to pet cleaning products, including pet brushes and pet deshedding systems. A pet brush, as provided herein, may comprise a body including a handle for gripping the pet brush, a first retractable deshedding blade, a deshedding brush disposed on a first surface of the pet brush, and a cleaning surface disposed on a second surface of the pet brush. The second surface may on be an opposite side of the body from the first surface. The first retractable deshedding blade is moveable between a retracted position within the body, and an extended position outside the body. For example, a retracting mechanism may be used move the first retractable deshedding blade between the retracted position within the body and the extended position outside the body. In certain embodiments, the retracting mechanism slidably directs the first retractable deshedding blade between the retracted position within the body and the extended position outside the body. In certain embodiments, a stopper element removes pet hair from the first retractable deshedding blade when the first retractable deshedding blade is moved from the extended position to the retracted position. The first retractable deshedding blade may include a plurality of protrusions that extend outwardly from a first end of the first retractable deshedding blade when it is extended from the body. The first retractable deshedding blade may include one of a flat edge, a sloping edge, and combinations thereof.

In certain embodiments, the pet brush further includes a second retractable deshedding blade that is moveable between a retracted position within the body and an extended position outside the body. In these embodiments, a stopper element may be disposed between the first retractable deshedding blade and the second retractable deshedding blade, where the stopper element is configured to remove pet hair when the first retractable deshedding blade and the second retractable deshedding blade are each moved from the extended position to the retracted position, respectively. The first retractable deshedding blade may include a first retractable deshedding blade flat edge and a first retractable deshedding blade sloping edge and the second retractable deshedding blade may include a second retractable deshedding blade flat edge and a second retractable deshedding blade sloping edge. The first retractable deshedding blade sloping edge may face the second retractable deshedding blade sloping edge.

The deshedding brush of the pet brush may include a plurality of protrusions. The cleaning surface may include a member selected from a group consisting of a lint cleaning brush, a microfiber material, a soft bristle brush, a sticky surface, and combinations thereof. A cover may be configured for receiving the pet brush. The cover may include an inner surface adapted to remove pet hair from the cleaning surface of the pet brush when the pet brush is removed from the cover. The cleaning surface may angle in a first direction, while the inner surface of the cover angles in a second opposite direction, for removing pet hair and dander from the pet brush. For example, the cleaning surface may include one of a lint cleaning brush, a microfiber material, and a soft bristle brush with bristles that angle in a first direction, while the inner surface includes one of a lint cleaning brush, a microfiber material, and a soft bristle brush with bristles that angle in a second opposite direction, such that the opposing bristles contact each other for removing pet hair and dander from the pet brush.

Advantageously, the pet brush of the present technology includes three different deshedding systems, namely, the retractable deshedding blade, the deshedding brush, and the cleaning surface. The retractable deshedding blade is adapted to remove fur in both directions during use. Accordingly, the undercoat, topcoat, and loose hair from pets may be efficiently and safely gathered and disposed of.

Furthermore, the pet brush has multiple ways to easily clean the pet brush as well as the areas surrounding the pet brush. For example, the stopper and the body remove hair from the retractable deshedding blade upon retraction of the deshedding blade into the body, the cleaning surface on the pet brush picks up loose hair from the pet and personal and household items, the cover cleaning surface removes hair from the pet brush as needed, and the pet hair that is collected in the cover is easily disposed of by removing the lid and disposing of the pet hair within the cover. As such, the pet brush as described herein provides certain benefits and advantages over pet brushes employing a single deshedding or cleaning system.

### EXAMPLES

Example embodiments of the present technology are provided with reference to the several figures enclosed herewith.

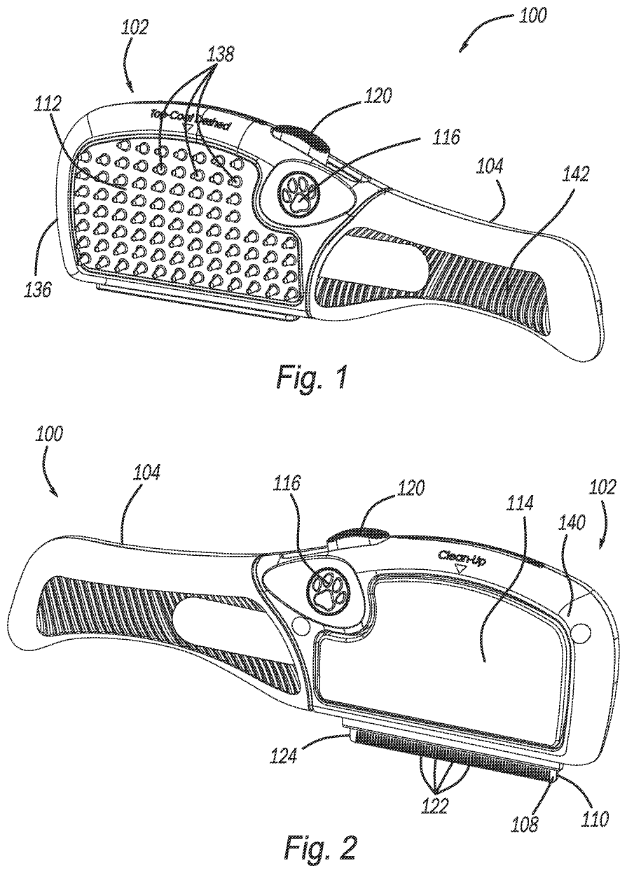

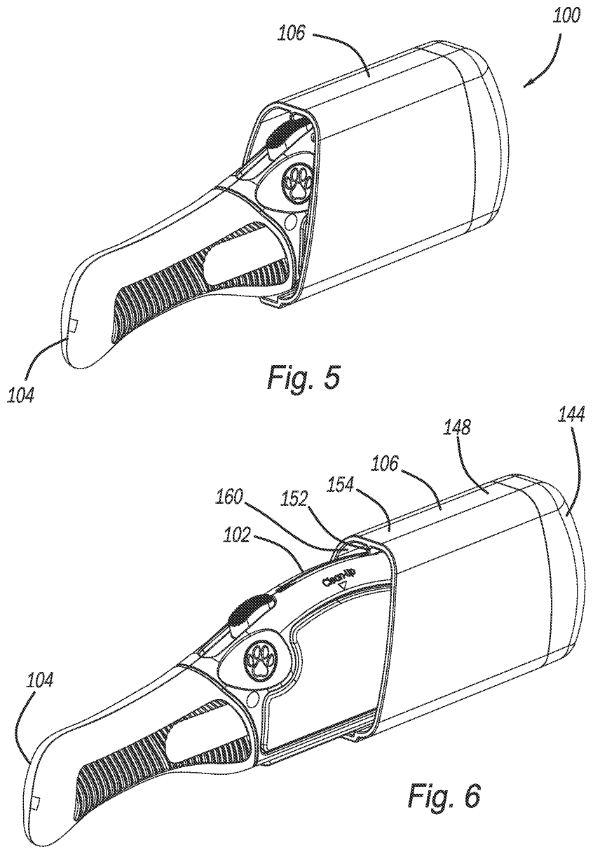

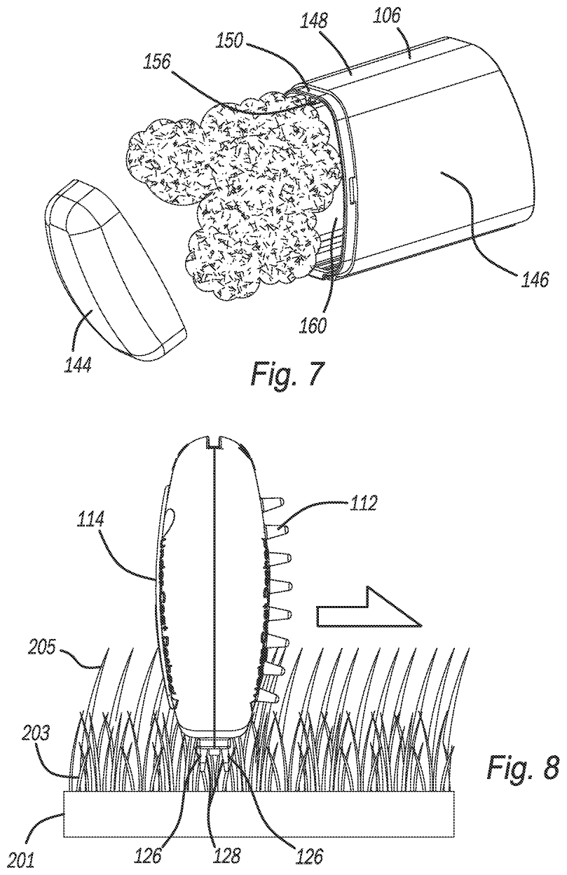

As shown in FIGS. 1-8, a pet brush 100 is provided. The pet brush 100 includes a body 102, a handle 104 for gripping the pet brush 100, one or more retractable deshedding blades 108, 110, and 130, a deshedding brush 112 disposed on a first surface, such as a front surface 136 of the pet brush 100, and a cleaning surface 114 disposed on a second surface, such as a rear surface 140 of the pet brush 100. The second surface may be on an opposite side of the body 102 from the first surface. The pet brush 100 may also include a cover 106 for securing and cleaning the pet brush 100.

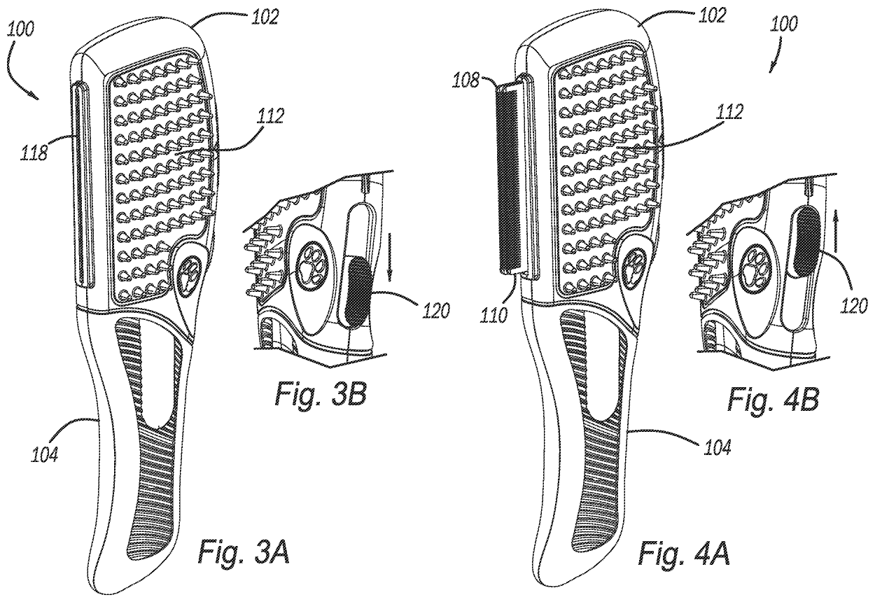

In a first embodiment of the present disclosure, such as shown in FIGS. 1-8 and 10A, the body 102 includes a first retractable deshedding blade 108, a second retractable deshedding blade 110, a deshedding brush 112, and a cleaning surface 114. The first retractable deshedding blade 108 and the second retractable deshedding blade 110 are housed in the body 102 when the pet brush 100 is not in use. The first retractable deshedding blade 108 and the second retractable deshedding blade 110 may alternate between a retracted position 118 in the body 102 of the pet brush 100 when the pet brush 100 is not in use, as shown in FIG. 3A, and an extended position outside of, or partially outside of the body 102 when the pet brush 100 is in use, as shown in FIG. 4A.

A retracting mechanism 120 may be used to move the first retractable deshedding blade 108 and the second retractable deshedding blade 110 from the retracted position within the body 102 to the extended position outside of, or partially outside of, the body 102. For example, as shown in FIG. 3B, the retracting mechanism 120 may be moved in a direction toward the handle to retract the first retractable deshedding blade 108 and the second retractable deshedding blade 110 into the body 102. In certain embodiments, when the first retractable deshedding blade 108 and the second retractable deshedding blade 110 are retracted into the body 102, the retracting mechanism 120 is locked in place. Retracting the first retractable deshedding blade 108 and the second retractable deshedding blade 110 into the body 102 may hide the first retractable deshedding blade 108 and the second retractable deshedding blade 110 while using the deshedding brush 112, and/or the cleaning surface 114.

As shown in FIG. 4B, the retracting mechanism 120 may be moved in a direction away from the handle to extend the first retractable deshedding blade 108 and the second retractable deshedding blade 110 from the body 102 for use. In certain embodiments, when the first retractable deshedding blade 108 and the second retractable deshedding blade 110 are extended from the body 102, the retracting mechanism 120 is locked in place. The retracting mechanism 120 may be disposed on one or more of the body 102 and the handle 104 of the pet brush 100 and may slidingly direct the first retractable deshedding blade 108 and the second retractable deshedding blade 110 according to certain embodiments of the present disclosure. It should be appreciated that one skilled in the art may employ a different extending and retracting mechanism 120, including manual and automatic mechanisms, as appropriately desired.

The first retractable deshedding blade 108 and the second retractable deshedding blade 110 may be made from a durable, easy-to-clean material. For example, the first retractable deshedding blade 108 and the second retractable deshedding blade 110 may be made from metal, plastic, silicone, or any other suitable material and combinations thereof. In certain embodiments, first retractable deshedding blade 108 and the second retractable deshedding blade 110 may have a comb-like appearance. For example, the first retractable deshedding blade 108 and the second retractable deshedding blade 110 may have a plurality of protrusions 122 extending outwardly from a first end 124 that is extended from the body 102 of the pet brush 100.

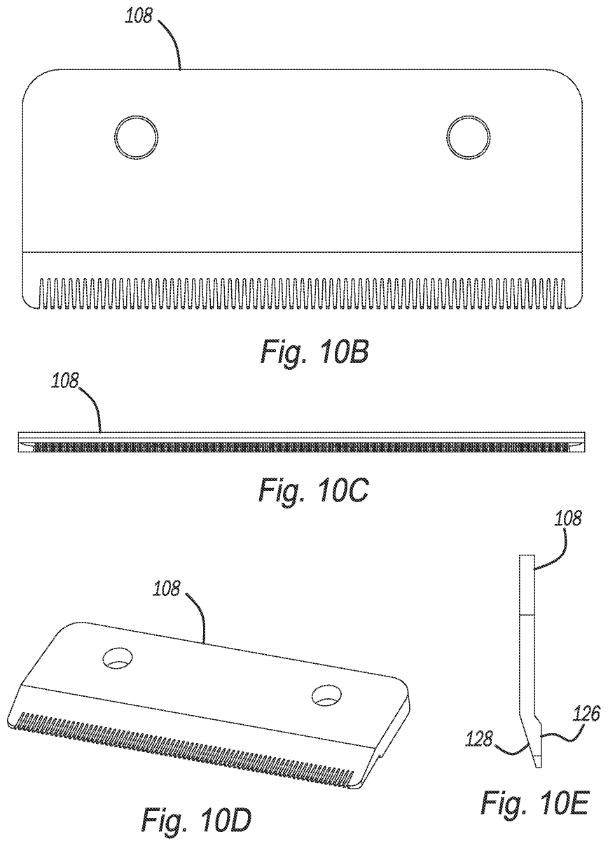

FIGS. 10B-10E depict a retractable deshedding blade 108, 110 of the first embodiment of the pet brush. The first retractable deshedding blade 108, is shown throughout FIGS. 10B-10E for ease of comprehension. However, as someone of ordinary skill in the art would understand, the first retractable shedding blade 108 and the second retractable deshedding blade 110 may each include one or more flat edges and sloped edges as appropriately desired. In addition, first retractable shedding blade 108 and the second retractable deshedding blade 110 may be similarly shaped or differently shaped, as discussed herein.

The first retractable deshedding blade 108 and the second retractable deshedding blade 110 may include a flat edge 126 opposite a sloped edge 128 for optimal hair removal. Alternatively, the first retractable deshedding blade 108 and the second retractable deshedding blade 110 may include a first flat edge and a second flat edge, such as shown in relation to the single retractable deshedding blade 130 that may include a first flat edge 133 and a second flat edge 135. In particular, the first retractable deshedding blade 108 and the second retractable deshedding blade 110 may be shaped as appropriately desired for removing hair from a pet.

In certain embodiments, as shown in FIG. 10A, the first retractable deshedding blade 108 is positioned to be the mirror image of the second retractable deshedding blade 110 such that the sloped edges 128 are facing one another for optimal hair removal in any direction. The body 102 may also include a stopper element 117 between the first retractable deshedding blade 108 and the second retractable deshedding blade 110. The stopper element 117 may be used to remove hair from first retractable deshedding blade 108 and the second retractable deshedding blade 110 upon retraction into the body 102. For example, the first retractable deshedding blade 108 and the second retractable deshedding blade 110 may be squeezed or biased against the stopper element 117, such that stopper element 117 pushes against the first retractable deshedding blade 108 and the second retractable deshedding blade 110 upon retraction into the body 102 to remove pet hair from the protrusions 122. It should be appreciated that one skilled in the art may employ a first retractable deshedding blade 108 and a second retractable deshedding blade 110, having any configuration, as appropriately desired. The pet brush 100 may be used to clean a topcoat 205 and an undercoat 203 on the skin 201 of a pet, as shown in FIG. 8.

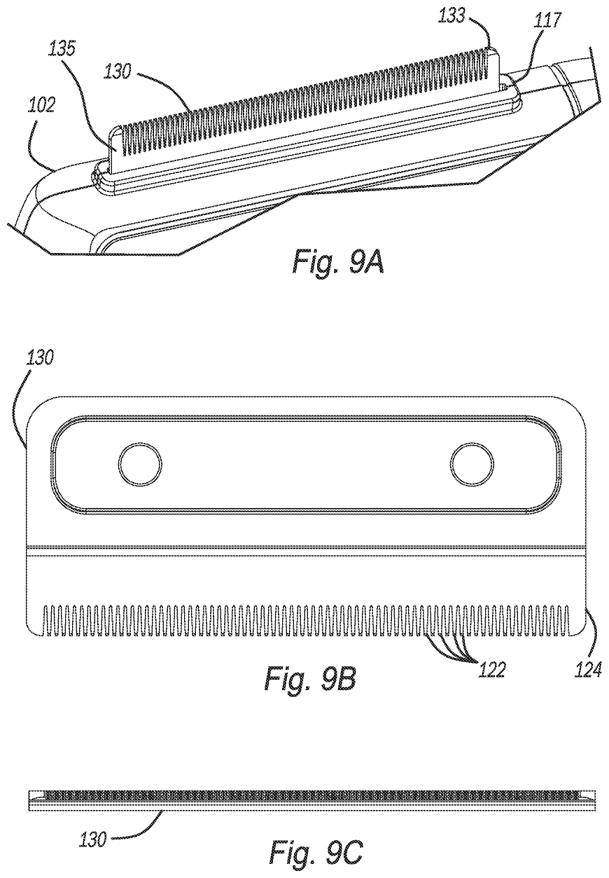

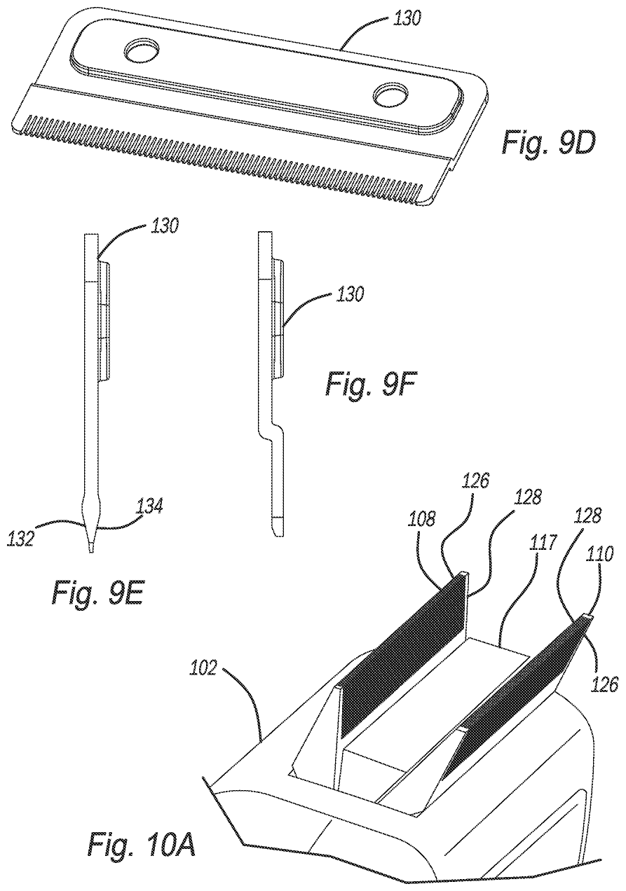

In a second embodiment, a single retractable deshedding blade 130, as shown in FIGS. 9A-9F, may be employed as an alternative to the first retractable deshedding blade 108 and the second retractable deshedding blade 110. The single retractable deshedding blade 130 may be housed in the body 102 when not in use. The single retractable deshedding blade 130 may alternate between a retracted position in the body 102 of the pet brush 100 when the pet brush 100 is not in use and an extended position outside of, or partially outside of, the body 102 when the pet brush 100 is in use. The retracting mechanism 120 may be employed to move the single retractable deshedding blade 130 from one position to the other.

The single retractable deshedding blade 130 may be made from any durable, easy-to-clean material. For example, single retractable deshedding blade 130 may be made from metal, plastic, silicone, or any other suitable material and combinations thereof. In certain embodiments, the single retractable deshedding blade 130 may have a comb-like appearance. More specifically, the single retractable deshedding blade 130 may have the plurality of protrusions 122 extending outwardly from the first end 124 that is extended from the body 102 of the pet brush 100. In certain embodiments, the single retractable deshedding blade 130 includes a first sloped edge 132 and a second sloped edge 134 for optimal hair removal in any direction. In yet another embodiment, the single retractable deshedding blade 130 has a first flat edge 133 and a second flat edge 135, to effectively eject hair from the single retractable deshedding blade 130 during retraction. The body 102 may also include a stopper element 117 that abuts the single retractable deshedding blade 130 and is used to remove hair from the single retractable deshedding blade 130 upon retraction into the body 102. As shown in FIG. 9A, the stopper element 117 can surround the single retractable deshedding blade 130, where the single retractable deshedding blade 130 retracts and extends relative to the body 102. For example, the single retractable deshedding blade 130 may be squeezed or biased against the stopper element 117, such that stopper element 117 pushes against the single retractable deshedding blade 130 upon retraction into the body 102 to remove pet hair from the protrusions 122. More than one stopper element 117 may be used, as appropriately desired. It should be appreciated that a skilled artisan may employ any deshedding blade 130, or more than one deshedding blade, such as a first retractable deshedding blade 108 and a second retractable deshedding blade 110 within the scope of this disclosure.

The deshedding brush 112 may be disposed on a front surface 136 of the pet brush 100. The deshedding brush 112 may be made from any durable, easy-to-maintain and easy-to-clean material. For example, the deshedding brush 112 may be made from silicone, plastic, rubber, synthetic rubber, metal, thermoplastic polyurethane, or any other suitable material, and combinations thereof. In certain embodiments, the deshedding brush 112 may have a brush-like appearance, as shown in FIGS. 1, 3A-4B, and 8. The deshedding brush 112 may include a plurality of brush protrusions 138 extending outwardly away from the body 102 of the pet brush 100. The deshedding brush protrusions 138 may be uniform in size and shape. Alternatively, each brush protrusion of the plurality of brush protrusions 138 may have a distinct size and shape. The deshedding brush 112 may be any suitable shape, size, color, and configuration, as determined by one skilled in the art. It should be appreciated that the deshedding brush 112 may be disposed anywhere on the pet brush 100 or in more than one location on the pet brush 100. A person skilled in the art may select any type of deshedding brush 112, as appropriately desired. The deshedding brush 112 may also be used as a pet massage surface or tool, as appropriately desired.

The cleaning surface 114 may disposed on a rear surface 140 of the pet brush 100 opposite a front surface 136 of the pet brush 100. The cleaning surface 114 may be a lint cleaning brush, a microfiber material, a soft bristle brush, a sticky surface, or any other suitable surface or material and combinations thereof adapted to pick up loose hair on or around a pet during use. The cleaning surface 114 may be any suitable shape, size, color, and configuration, as appropriately desired. It should be appreciated that the cleaning surface 114 may be disposed anywhere on the pet brush 100 or in more than one location on the pet brush 100, as appropriately desired. It should be further appreciated that a skilled artisan may employ any suitable cleaning surface, within the scope of this disclosure, and that the cleaning surface 114 may be used to remove loose hair from a pet or personal and household items such as clothing, furniture, and any other surface.

In certain embodiments, the pet brush 100 includes a deshedding brush 112 on the front surface 136 of the pet brush 100 and a cleaning surface 114 on the rear surface 140 of the pet brush 100. In certain embodiments, the deshedding brush 112 may be disposed on the front surface 136 and the rear surface 140 of the body 102. In particular, any appropriately desired combination of the deshedding brush 112 and/or the cleaning surface 114 may be selected by a user.

The handle 104 may be disposed adjacent the body 102 of the pet brush 100. When the pet brush 100 is vertically oriented with the body 102 of the pet brush 100 extending upwardly from the handle 104, the first retractable deshedding blade 108 and the second retractable deshedding blade 110 may be positioned directly above the handle 104. The handle 104 may be integral with the body 102 or permanently or semi-permanently connected to the body 102, as appropriately desired. Examples of materials that may be used to fabricate the handle 104 include, but are not limited to, silicone, plastic, rubber, metal, or any other single material or combination of suitable materials. The handle 104 may be any appropriately desired shape, size, and configuration that is comfortable and optimally ergonomic to hold during use. One or more finger grips 116 or one or more gripping surfaces 142 may be employed to allow for a more secure grip during use.

The body 102 may be fabricated from any suitable material selected by one skilled in the art. For example, the body 102 may include silicone, plastic, rubber, or any other rigid or semi-rigid material and combinations thereof. The body 102 may be any suitable shape, size, and configuration, as appropriately desired. In certain embodiments, the body 102 is 110.0 mm in length, 76.1 mm in height, and 36.0 mm in width. In certain embodiments, the pet brush 100 may be 242.5 mm in length, 76.1 mm in height, and 36.0 mm in width. However, as would be understood by someone of ordinary skill in the art, the pet brush 100 may be any appropriately desired size for targeting the undercoat 203 of a pet, the topcoat 205, and any loose hair on or around the pet. In certain embodiments, one or more finger grips 116 or one or more gripping surfaces 142 may be disposed on the body 102. The body 102 may also include a stopper element 117 that is used to remove hair from the retractable deshedding blades, 108, 110, and 130 upon retraction into the body 102. The deshedding blades, 108, 110, and 130 may be housed in the body 102 when the pet brush is not in use.

The cover 106 may include a lid 144 and a sidewall 146. In certain embodiments, the lid 144 is connected to the sidewall 146 at a first end 148 of the cover 106. The lid 144 may be integral with the sidewall 146 or removably or semi-removably connected to the sidewall 146, as appropriately desired. In certain embodiments, the sidewall 146 includes a rim 150 that forms a friction fit with the lid 144 at the first end 148 of the cover 106. An opening 152 at a second end 154 of the cover 106 opposite the first end 148 of the cover 106 is adapted to receive the pet brush 100. The opening 152 may be any suitable shape, size, and configuration capable of receiving the pet brush. The cover 106 may be fabricated from a rigid or semi-rigid material. For example, the cover may be fabricated from plastic, silicone, rubber, metal or any other appropriately desired single material or combination of materials. In certain embodiments, the pet brush 100 is secured in a cavity formed by the lid 144 and the sidewall 146 of the cover 106 using a friction fit. It should be appreciated that any means for securing the pet brush 100 in the cavity of the cover 106 may be used, as appropriately desired. A locking mechanism may be included in certain embodiments.

An inner surface of the sidewall 146 may include a cover cleaning surface 160. The cover cleaning surface 160 may be a lint cleaning brush, a microfiber material, a soft bristle brush, a sticky surface, or any other suitable surface or material adapted to remove hair from the cleaning surface 114 disposed on the pet brush 100 or the deshedding brush 112 disposed on the pet brush 100. The cover cleaning surface 160 may be the same surface or material as the cleaning surface 114 disposed on the pet brush 100, or a different surface or material. The cover cleaning surface 160 may be any suitable shape, size, color, configuration, and texture, as appropriately desired. It should be appreciated that the cover cleaning surface 160 may be disposed anywhere on the pet brush 100 or in more than one location on the pet brush 100, as appropriately desired. A skilled artisan may include any suitable cover cleaning surface 160, within the scope of this disclosure. In certain embodiments, the cleaning surface 114 includes cleaning surface is angled in a first direction and the cover cleaning surface 160 is angled in a second direction, opposite the first direction, for cleaning the pet brush 100. For example, the cleaning surface 114 may include one of a lint cleaning brush, a microfiber material, and a soft bristle brush with bristles that angle in a first direction, while the inner surface 160 includes one of a lint cleaning brush, a microfiber material, and a soft bristle brush with bristles that angle in a second opposite direction, such that the opposing bristles contact each other for removing pet hair and dander from the pet brush 100.

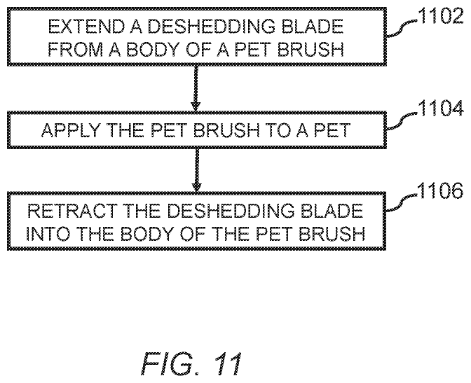

In yet another embodiment of the present disclosure, a method of using the pet brush 100 is shown in FIG. 11. In step 1102, a deshedding blade 108, 110, 130 is extended from a body 102 of the pet brush 100. In certain embodiments, a cover 106 may be removed from the pet brush before use. In step 1104, the pet brush 100 is applied to a pet using the deshedding blade 108, 110, 130, a deshedding brush 112, and a cleaning surface 114, or a combination thereof. The cleaning surface 114 may also be used to gather pet hair from personal and household items such as clothing and furniture, as appropriately desired. In step 1106, the deshedding blade 108, 110, 130 is retracted back into the body 102 of the pet brush 100. Pet hair that is removed from the deshedding blade 108, 110, 130 during retraction may be collected.

The pet brush 100 may also be engaged with a cover cleaning surface 160 of the cover 106 to remove pet hair from the deshedding blade(s) 108, 110, 130 and the cleaning surface 114, as needed. As would be apparent to someone of ordinary skill in the art, one or more of these steps may be repeated in any order until a desirable amount of pet hair has been removed from the pet. Final steps may include removing the lid 144 from the cover 106 to dispose of any pet hair that has accumulated in the cover 106 and securing the pet brush 100 in the cover 106 for future use.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A pet brush, comprising:
a body;
a handle for gripping the pet brush;
a first retractable deshedding blade, where the first retractable deshedding blade is moveable between a retracted position within the body, and an extended position outside the body;
a deshedding brush disposed on a first surface of the pet brush; and
a cleaning surface disposed on a second surface of the pet brush, where the second surface is on an opposite side of the body from the first surface.

2. The pet brush of claim 1, wherein the body includes a retracting mechanism to move the first retractable deshedding blade from the retracted position within the body to the extended position outside the body.

3. The pet brush of claim 2, wherein the retracting mechanism slidably directs the first retractable deshedding blade between the retracted position within the body and the extended position outside the body.

4. The pet brush of claim 3, including a stopper element configured to remove pet hair from the first retractable deshedding blade when the first retractable deshedding blade is moved from the extended position outside the body to the retracted position within the body.

5. The pet brush of claim 1, wherein the first retractable deshedding blade includes a plurality of protrusions that extend outwardly from a first end of the first retractable deshedding blade.

6. The pet brush of claim 1, wherein the first retractable deshedding blade includes a first flat edge and a second opposing flat edge.

7. The pet brush of claim 1, wherein the first retractable deshedding blade includes a first sloping edge and a second opposing sloping edge.

8. The pet brush of claim 1, wherein the first retractable deshedding blade includes a first flat edge and a second opposing sloping edge.

9. The pet brush of claim 1, further including a second retractable deshedding blade, where the second retractable deshedding blade is moveable between a retracted position within the body, and an extended position outside the body;

10. The pet brush of claim 9, further including a stopper element placed between the first retractable deshedding blade and the second retractable deshedding blade, where the stopper element is configured to remove pet hair when the first retractable deshedding blade and the second retractable deshedding blade are moved from the extended position outside the body to the retracted position within the body.

11. The pet brush of claim 10, wherein the first retractable deshedding blade includes a first retractable deshedding blade flat edge and a first retractable deshedding blade sloping edge and the second retractable deshedding blade includes a second retractable deshedding blade flat edge and a second retractable deshedding blade sloping edge.

12. The pet brush of claim 11, wherein the first retractable deshedding blade sloping edge faces the second retractable deshedding blade sloping edge.

13. The pet brush of claim 1, wherein the deshedding brush includes a plurality of protrusions.

14. The pet brush of claim 1, wherein the cleaning surface includes a member selected from a group consisting of a lint cleaning brush, a microfiber material, a soft bristle brush, a sticky surface, and combinations thereof.

15. The pet brush of claim 1, further comprising a cover for receiving the pet brush.

16. The pet brush of claim 15, wherein the cover includes an inner surface adapted to remove pet hair from the cleaning surface of the pet brush when the pet brush is removed from the cover.

17. The pet brush of claim 16, wherein the cleaning surface angles in a first direction and the inner surface of the cover angles in a second direction, opposite the first direction.

18. A method of using a pet brush comprising:
extending a deshedding blade from a body of the pet brush;
applying the pet brush to a pet using one of the deshedding blade, a deshedding brush, and a cleaning surface, or a combination thereof; and
retracting the deshedding blade into the body of the pet brush, where during retraction of the deshedding blade, pet hair is collected from the deshedding blade.

19. The method of claim 18, further comprising engaging the pet brush with a cover to remove pet hair from the deshedding brush and the cleaning surface.

20. The method of claim 19, further comprising removing a lid from the cover to dispose of pet hair collected within the cover.
